(19) United States
(12) Patent Application Publication
(10) Pub. No.: US 2004/0030880 A1
(43) Pub. Date: Feb. 12, 2004

(54) Method for managing computer hardware configuration information

(75) Inventor: Tooru Kitagawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/612,942

(22) Filed: Jul. 7, 2003

Related U.S. Application Data
(63) Continuation of application No. PCT/JP01/00175, filed on Jan. 12, 2001.

(51) Int. Cl. G06F 9/00

(52) U.S. Cl. 713/1

(57) ABSTRACT

Hardware configuration information, such as version number information of each device in a computer, is obtained at a plurality of predetermined timing sets and is stored in a nonvolatile storage medium. Accordingly, it becomes easier to manage the hardware configuration information obtained at the plurality of timing sets in a integrated manner.

### FIELD OF THE INVENTION

The present invention relates to a method for easy management of hardware configuration information on a computer such as a personal computer.

### BACKGROUND OF THE INVENTION

In general, hardware configuration information of devices constituting a computer (CPU, memory, hard disk drive, other various types of drives, peripheral devices, optional devices, etc.), such as manufacturer's name, product name, type, performance, and firmware version number is acquired through a program such as BIOS (Basic Input Output System) and OS (Operating System). The acquired hardware configuration information can be identified by use of an information screen of the BIOS or a property screen of the OS (for example, Windows by Microsoft). Exemplary configuration information of the CPU includes manufacturer's name, product name, clock operation speed, etc., and also exemplary configuration information of memory (RAM) includes memory capacity, bus clock speed, etc.

Further, with respect to particular information on a particular device (for example, a firmware version number lorded on a device of interest), configuration information cannot be acquired through the BIOS or the OS. Such information can be acquired through a particular information acquisition program.

In such a way, in the conventional method, hardware configuration information is acquired from each plurality of programs such as BIOS, OS and particular information acquisition programs), which causes trouble when managing such information.

Accordingly, for example, in such a work as identifying a faulty portion in the event of a computer failure, when it is required to confirm whether or not the hardware configuration information has been changed, it is necessary to acquire hardware configuration information from each program and perform verification processing on an information item-by-item basis. This work is laborious and requires a large amount of time.

### DISCLOSURE OF THE INVENTION

It is an object of the present invention to provide a method for managing hardware configuration information enabling easy management of hardware configuration information of each device in a computer.

In a management method of hardware configuration information performed by a computer for managing hardware configuration information of each device constituting the computer concerned, the method for managing computer hardware configuration information to attain the above-mentioned object includes the steps of: acquiring hardware configuration information of each device at a plurality of predetermined timing sets; and storing the acquired hardware configuration information into a predetermined nonvolatile storage medium.

The computer is, for example, a personal computer, and the devices include CPU, memory, hard disk drive, optical disk drive, peripheral devices, optional devices, etc. Further, hardware configuration information includes manufacturer name, product name, firmware version number, etc. of each device.

Further, preferably, the management method of hardware configuration information in accordance with the present invention, may include the steps of: reading out hardware configuration information acquired in the past and stored in a nonvolatile storage medium; comparing the hardware configuration information read out with the aforementioned acquired hardware configuration information; and displaying the comparison result onto a predetermined display unit.

According to the present invention, there is provided a recording medium in which a program executing the management method of hardware configuration information is stored. Further, there is provided a computer executing the above-mentioned method for managing hardware configuration information in accordance with the present invention.

### BRIEF DESCRIPTION OF THE DRAWINGS

FIG. 1 shows an exemplary configuration of a personal computer, as one example of a computer in accordance with an embodiment of the present invention.

FIG. 2 shows a flowchart of hardware configuration information management processing by means of a management program in accordance with the embodiment of the present invention.

FIG. 3 shows a flowchart of hardware configuration information acquisition processing at the time of executing the BIOS, which is performed in a management program of hardware configuration information in accordance with the embodiment of the present invention.

FIG. 4 shows examples of a variety of hardware configuration information acquired by the management program in the processing shown in FIG. 3.

FIG. 5 shows a flowchart of hardware configuration information acquisition processing after OS is activated, which is performed in the management program in accordance with the embodiment of the present invention.

FIG. 6 shows examples of a variety of hardware configuration information acquired by the management program in the processing shown in FIG. 5.

FIG. 7 shows screen examples of a consistency message and an inconsistency message.

FIG. 8 shows examples of hardware configuration information acquired in the past (at the time of executing the BIOS) as an object of comparison.

FIG. 9 shows examples of hardware configuration information acquired in the past (after the OS is activated) as an object of comparison.

FIGS. 10 and 11 show flowcharts with regard to another hardware configuration information management processing by means of the management program in accordance with the embodiment of the present invention.

### PREFERRED EMBODIMENTS OF THE PRESENT INVENTION

The preferred embodiments of the present invention are described hereinafter referring to the charts and drawings. However, it is to be noted that the technical scope of the present invention is not limited to the embodiments described below.

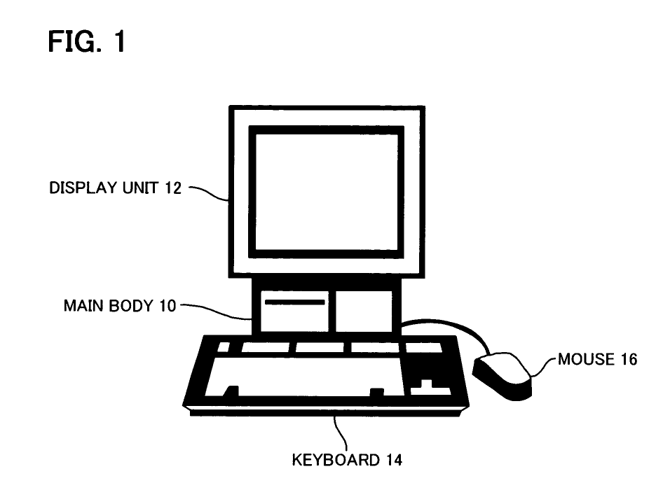

FIG. 1 shows an exemplary configuration of a personal computer as one example of a computer in accordance with the embodiment of the present invention. The personal computer is constituted of a main body 10 having CPU, memory, and storage such as a hard disk drive (HDD) mounted inside, display unit 12, keyboard 14, pointing device (mouse) 16, etc. In the hard disk drive of the main body 10, an operating system (for example, Windows produced by Microsoft Corporation), a variety of application programs, and data are stored. Also, in the main body 10, there are mounted a floppy disk drive, an optical disk drive (such as CD-ROM, CD-R/RW and DVD-ROM), etc. Further, in the main body 10, a variety of interfaces are provided, and a variety of peripheral devices or optional devices (printer, scanner, digital camera, etc.) can be connected through these interfaces.

In order to manage the hardware configuration information of such a personal computer, according to the embodiment of the present invention, a variety of hardware configuration information is acquired at the time of executing the BIOS and after the OS is activated, and a management method of hardware configuration information (hereinafter simply referred to as management method) is provided in a predetermined storage medium in the form of a single file. Further, there are provided a management program of hardware configuration information (hereinafter simply referred to as management program) to enable the management method concerned, and also a computer in which the management program concerned is executed. Here, computer states at the time of executing the BIOS and after the OS is activated are also referred to as an operating state.

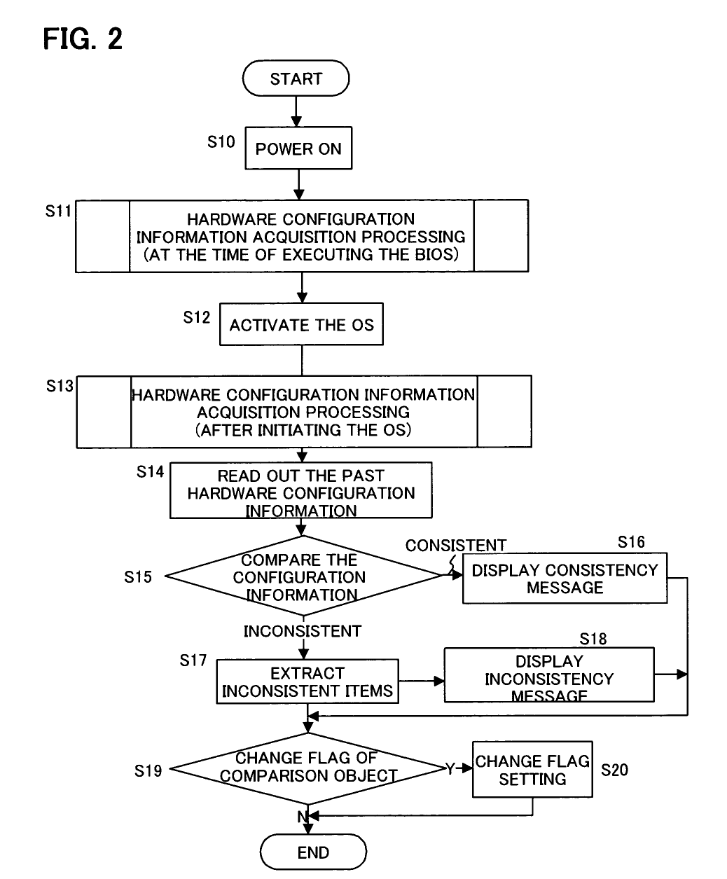

FIG. 2 shows a flowchart of hardware configuration information management processing by means of the management program in accordance with the embodiment of the present invention. This hardware configuration information management processing in accordance with the embodiment of the invention is to be applied to a computer of stand-alone type. Further, the management program in accordance with the embodiment of the invention is classified into a management program which is executed at the time of executing the BIOS, and a management program which is executed under the direction of the OS after the OS is activated.

First, when power of the personal computer is switched on (S10), the BIOS is activated. The management program to be executed at the time of executing the BIOS is incorporated in the BIOS. When the BIOS is activated, the management program is executed automatically. Or, it is also possible to activate the management program at the time of executing the BIOS activated by user's operation after a request for operation (such as depressing a function key of a predetermined number on the keyboard) is. displayed on the screen.

The management program executes hardware configuration information acquisition processing at the time of executing the BIOS, as described in the following (S11).

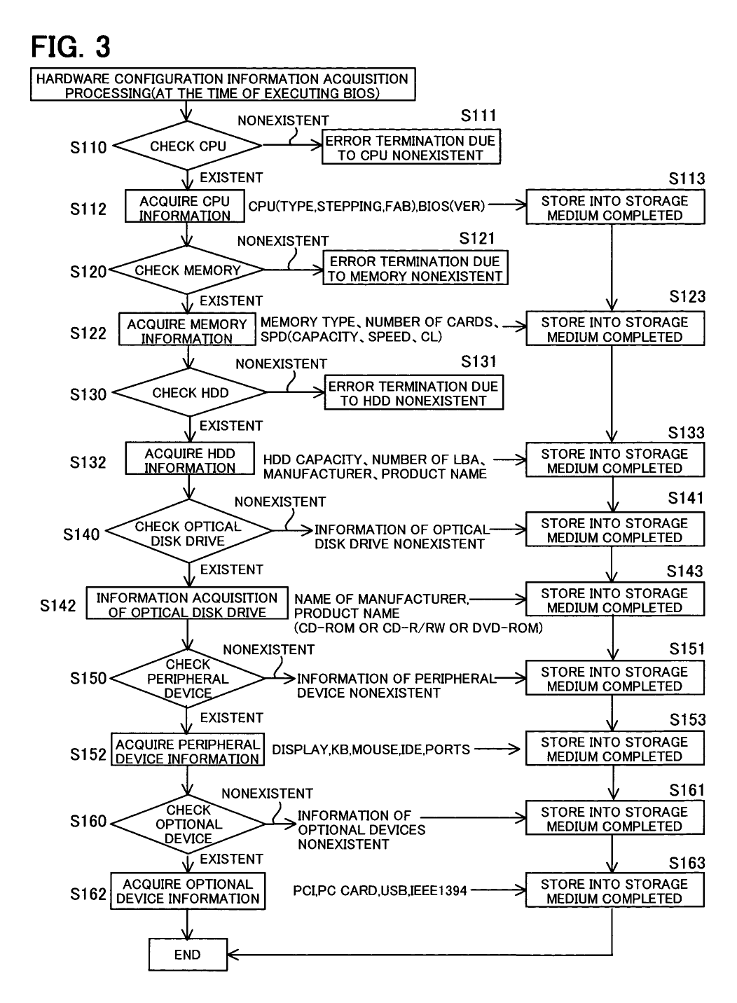

FIG. 3 shows a flowchart of the hardware configuration information acquisition processing at the time of executing the BIOS in a hardware configuration information management program in accordance with the embodiment of the present invention.

In FIG. 3, the management program first checks whether or not the CPU exists (S110). For example, when the CPU has been removed from the personal computer because of theft, etc., the management program cannot find the CPU, and therefore the process is terminated as an error at this stage (S111).

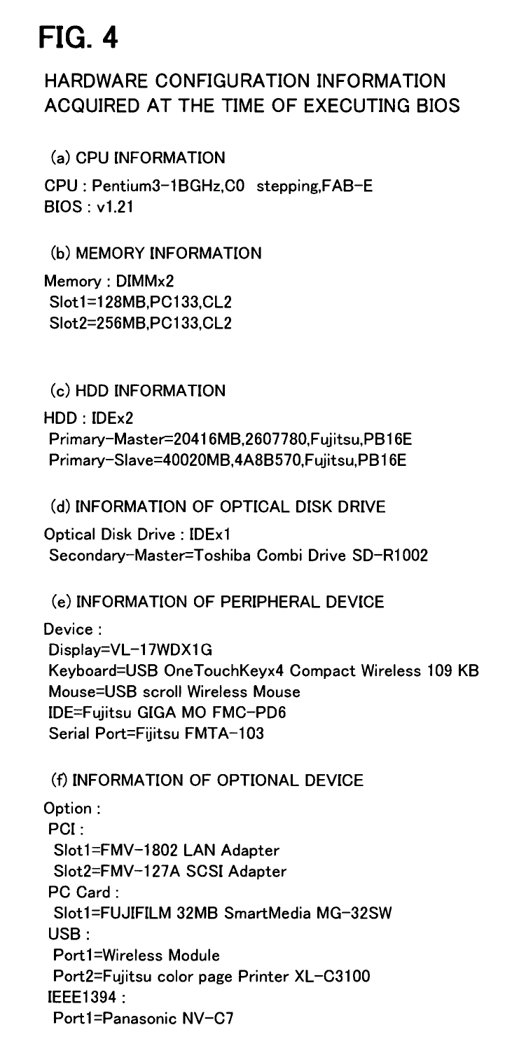

When the CPU exists, the management program acquires the hardware configuration information of the CPU (CPU information) stored in the CPU (S112). The CPU information includes CPU type (type), stepping (stepping), manufacturing factory name (fab), and moreover, the BIOS version number (BIOS(ver)), etc. FIG. 4 shows examples of hardware configuration information acquired by the management program in the process shown in FIG. 3. In FIG. 4 (a), an example of CPU information is shown.

When the management program acquires the CPU information, the management program stores this information into a predetermined nonvolatile storage medium (S113). The nonvolatile storage medium is, for example, a disk-type storage medium such as a floppy disk, or a nonvolatile memory such as a memory card. A hard disk drive mounted inside the computer may also be applicable as the storage medium.

The management program then checks there is mounted a memory (S120). Similar to the aforementioned case, when the memory has been removed from the personal computer, the management program terminates the processing as an error at this stage (S121).

When the memory exists, the management program reads out the hardware configuration information of the memory (memory information) stored in the memory (S122). The memory information includes memory type, number of cards, SPD (capacity, speed, CL (CAS latency)), etc. In FIG. 4 (b), an example of the memory information is shown. When the memory information is acquired, the management program stores this information into the predetermined storage medium (S123).

Next, the management program checks there is mounted a hard disk drive (HDD) (S130). Similar to the aforementioned case,. when the HDD has been removed from the personal computer, the management program terminates the processing as an error at this stage (S131).

When the HDD exists, the management program reads out the hardware configuration information of the HDD (HDD information) stored in the HDD (S132). The HDD information includes HDD capacity, number of LBA (logical block addresses), manufacturer's name, product name, etc. In FIG. 4 (c), an example of the HDD information is shown. When the HDD information is acquired, the management program stores this information into the predetermined storage medium (S133).

Further, the management program checks there is mounted an optical disk drive (S140). In case the optical disk drive is not mounted on the personal computer, the management program stores information indicating that any optical disk drive is not mounted (‘no optical disk drive’ information) into the predetermined storage medium (S141). The optical disk drive and the devices described in the following are not essential devices for configuring personal computers, while the above-mentioned CPU, memory, HDD are the devices essentially required. Therefore, in the case these devices do not exist, the information indicating that each device of interest is not mounted is stored into the storage medium.

When the optical disk drive exists, the management program reads out the hardware configuration information of the optical disk drive (optical disk drive information) stored in the optical disk drive (S142). The optical disk drive information includes manufacturer's name, product name, etc. In FIG. 4 (d), an example in the case of the optical disk drive is shown. When the optical disk drive information is acquired, the management program stores this information into the predetermined storage medium (S143).

The management program checks whether or not there are mounted optional devices, similar to the above-mentioned acquisition processing of optical disk drive information (S150, S160). When these optional devices are not mounted, the management program stores into the storage medium the information indicating that these devices are not mounted (S151, S161). When these devices are mounted, the management program acquires hardware configuration information related to the mounted devices from the devices of interest (S152, S162), and stores the acquired hardware configuration information into the storage medium (S153, S163). Peripheral devices are, for example, display unit, keyboard, mouse, device(s) connected to an IDE port, and device(s) connected to a serial port. The hardware configuration information of these peripheral devices (peripheral device information) is manufacturer's name, product name, etc., of each device of interest. Also, optional devices are, for example, devices connected to PCI slot, PC card slot, USB port, or IEEE 1394 port, and the hardware configuration information of these optional devices (optional device information) is also manufacturer's name, product name, etc., of each device of interest. In FIG. 4 (e), an example of peripheral device information is shown. Also in FIG. 4 (f), an example of optional device information is shown.

Thereafter, the OS is activated (S12). The OS may be activated automatically after the completion of hardware configuration information acquisition processing at the time of executing the BIOS. Or, the OS may be activated by a user's operation after a selection message for the selection of either power shutdown or OS activation is displayed on the display screen.

When the OS is activated, the management program to be executed after activation of the OS successively executes hardware configuration information acquisition processing after the OS is activated (S13). The management program may be activated either automatically after the OS is activated, or by a user's activation operation.

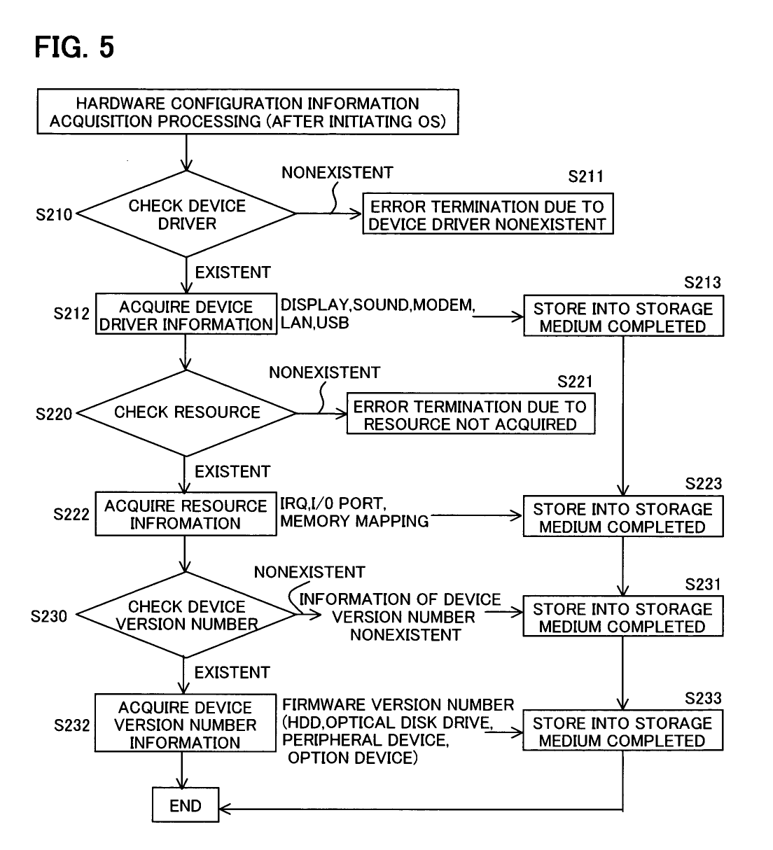

FIG. 5 shows a flowchart of hardware configuration information acquisition processing to be executed after the OS is activated, which is performed by the management program in accordance with the embodiment of the present invention. First, the management program searches the OS and checks whether or not there are installed device drivers (S210). The device drivers are programs for driving each device, and are incorporated in the OS. When no device driver is installed, the management program is terminated. as an error at this stage (S211).

When there is found any installed device driver, the management program acquires hardware configuration information of the device driver (device driver information) which is included in the device driver concerned (S212). The device driver information includes device driver name, version information thereof, etc.

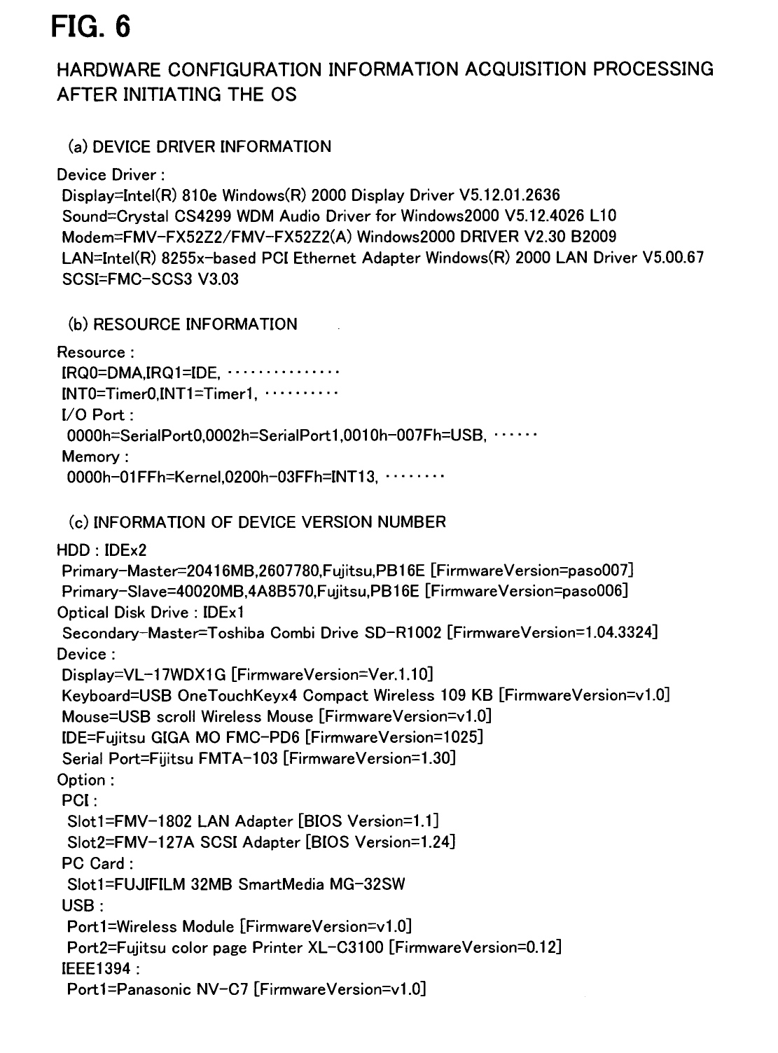

FIG. 6 shows examples of a variety of hardware configuration information acquired by the management program in the processing shown in FIG. 5. In FIG. 6 (a), an example of device driver information is shown. When the device driver information is acquired, the management program stores this information into the predetermined storage medium (S213).

Next, the management program checks resources set in the OS (S220). When there is no set resource, the processing is terminated as an error at this stage (S221). When any resource is set, the management program acquires the resource setting information of each resource having been set (resource information). The resource information includes resource types of IRQ, I/O ports, DMA, memory mapping, etc. In FIG. 6 (b), an example of resource information is shown. When the resource information is acquired, the management program stores this resource information into the storage medium (S223).

The management program checks each mounted firmware version number (device version number) on a device-by-device basis (CPU, memory, HDD, optical disk drive, peripheral device, optional device, etc.), which was acquired at the time of executing the BIOS, when a firmware is mounted on the device concerned (S230). Firmware is a program incorporated in a device. The device version number, which is hardware configuration information, is stored in the firmware of each device. When there is no device version number stored in each device (including the case of no firmware mounted), information indicative of no device version information (no device version information) is stored into the predetermined storage medium (S231). When there is stored device version number information in each device, the management program reads out this version number (S232), and stores this information into the predetermined storage medium (S233). In FIG. 6 (c), examples of various types of device version number information are shown.

The above-mentioned device driver information and resource information are information inside the OS, and therefore the information can be acquired by the management program which is executed after activation of the OS. However, various kinds of device version number information depends on the configuration of each device firmware, and accordingly this information may also be acquired by the management program executed at the time of executing the BIOS, not only by the management program executed after activation of the OS.

Referring back to FIG. 2, when the management program acquires predetermined hardware configuration information after the OS is activated, the management program performs comparison processing of hardware configuration information, which will be explained in the following.

More specifically, when the management program completes the hardware configuration information acquisition processing after the OS is activated, the management program reads out the hardware configuration information which was acquired in the past and stored in the storage medium (S14). In the storage medium, for example, a plurality sets of hardware configuration information which were acquired in the past. In such a case, a flag for identifying the hardware configuration information to be compared (comparison object flag) is set in one of the hardware configuration information sets. The management program reads out the hardware configuration information in which the comparison object flag was set. Thereafter, the management program compares the hardware configuration information acquired this time with the hardware configuration information which was read out (S15).

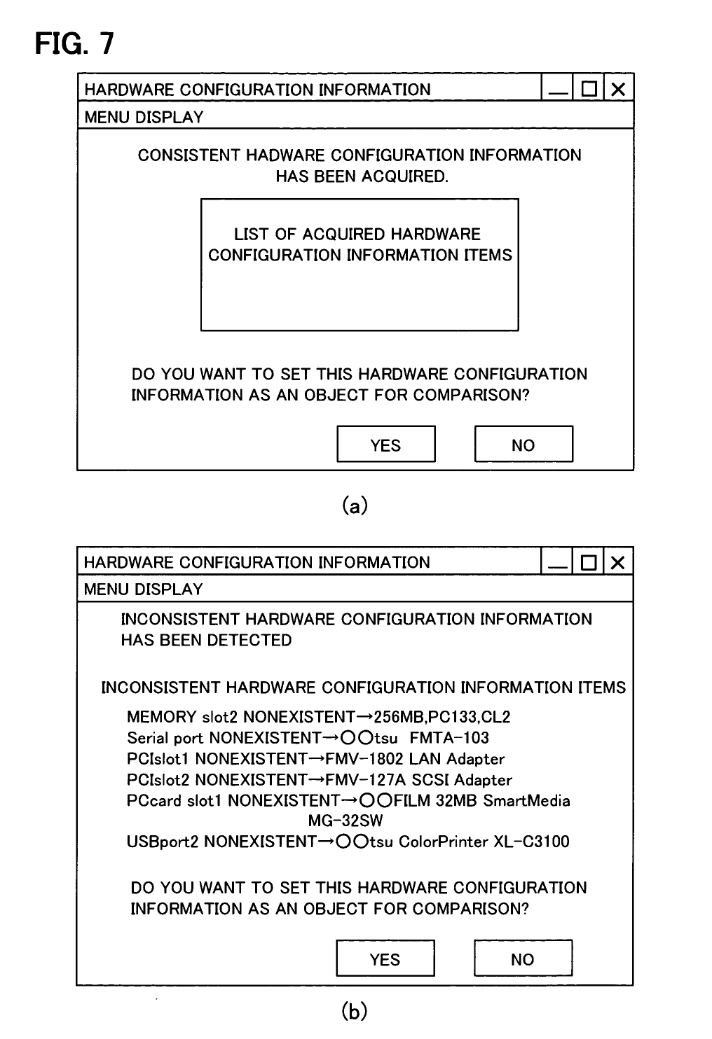

In the comparison performed in step S15, when the entire items in the two hardware configuration information sets coincide with each other, the management program displays a consistency message onto the display screen (S16). In FIG. 7 (a), an exemplary screen of the consistency message is shown. In this display screen, a selection message is displayed together with the consistency message, so as to select whether or not the hardware configuration information is to be replaced by the hardware configuration information acquired this time. When the user operates to instruct replacement (S19), the management program changes the setting of the comparison object flag (S20).

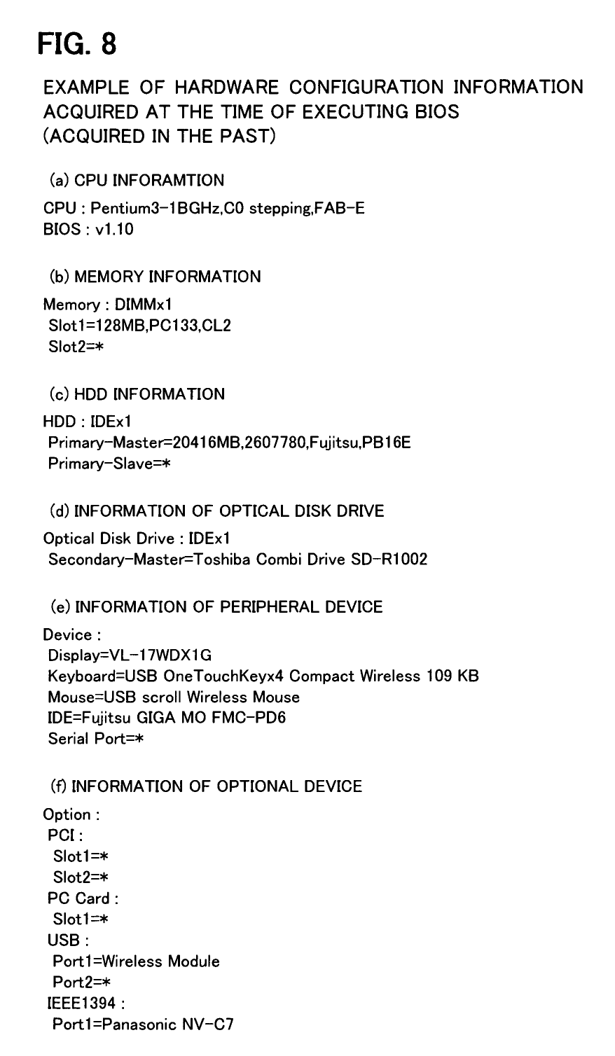

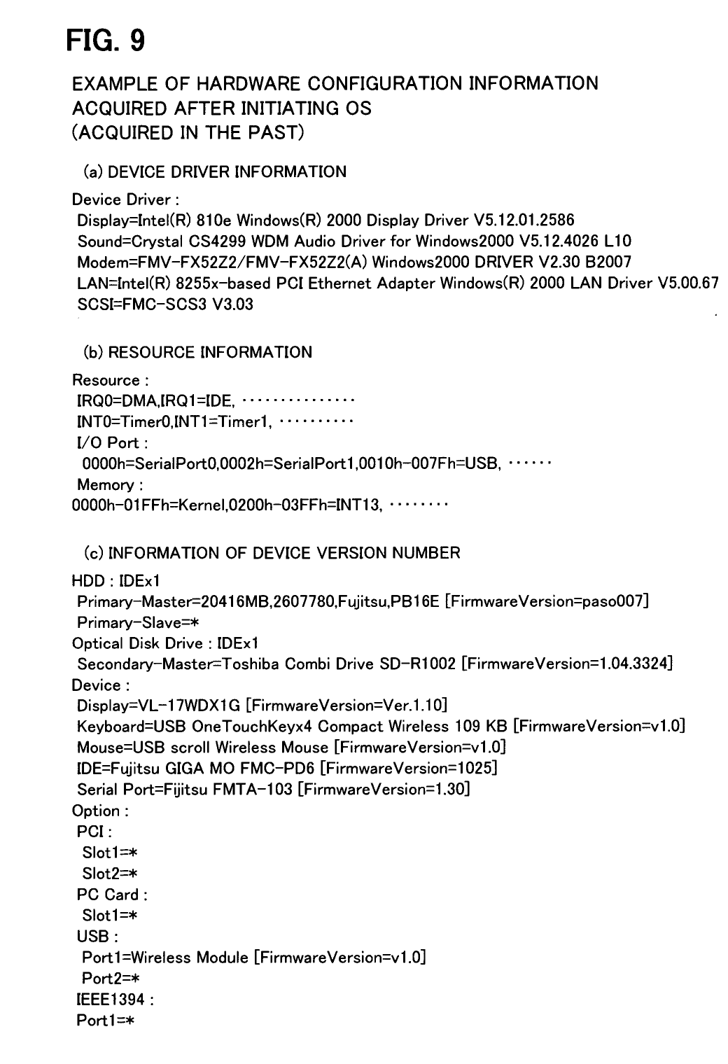

Meanwhile, in the comparison performed in step S15, when there is any inconsistent items between the two hardware configuration information sets, the management program extracts the item(s) of inconsistent hardware configuration information (S17), and displays this onto the display screen as an inconsistency message (S18). In FIG. 7 (b), an exemplary screen of the inconsistency message is shown. In addition, FIG. 8 shows an exemplary hardware configuration information acquired at the time of executing the BIOS in the past, which corresponds to FIG. 4, and FIG. 9 shows exemplary hardware configuration information acquired after the OS is activated in the past, which corresponds to FIG. 6. The inconsistent items shown in FIG. 7 (b) are derived from the comparison between FIG. 8 and FIG. 4, and between FIG. 9 and FIG. 6.

Also, in the inconsistency message screen, as in the case of the consistency message, the aforementioned selection message is displayed on the display screen. When changing the hardware configuration information to be compared, the management program changes the setting of the comparison object flag (S18).

Thus, in accordance with the embodiment of the present invention, it becomes possible to manage the acquired hardware configuration information easily by acquiring computer hardware configuration information efficiently and managing the information in an integrated manner.

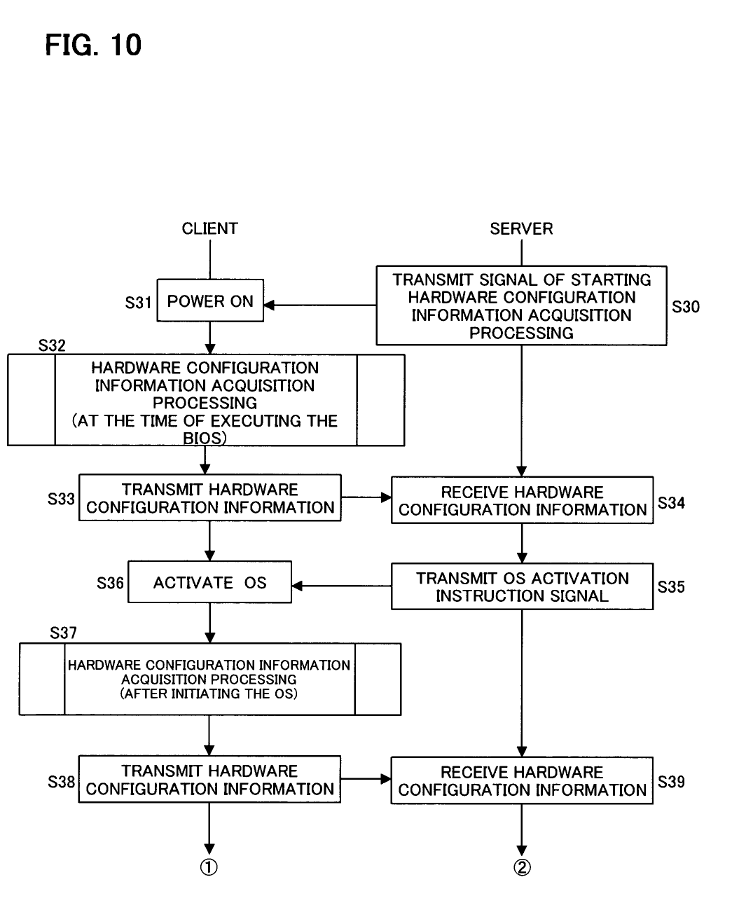

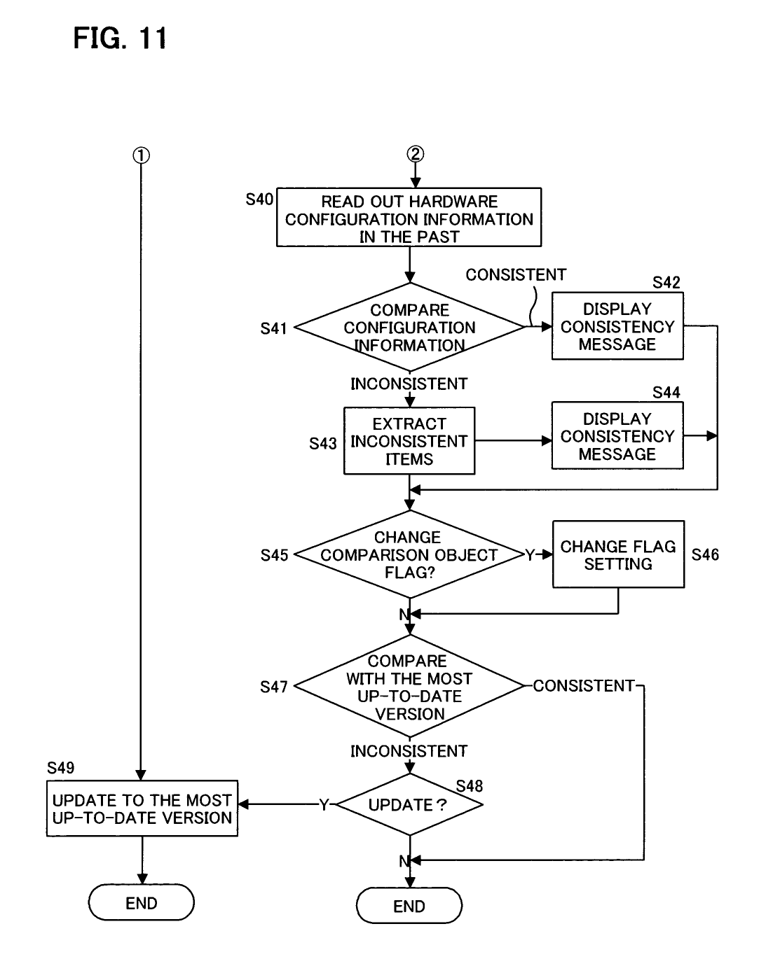

FIGS. 10 and 11 show flowcharts of another hardware configuration information management processing by the management program in accordance with the embodiment of the present invention. The hardware configuration information management processing according to this embodiment is applied to client-server type computers. In this hardware configuration information management processing, a client performs hardware configuration information acquisition processing based on an instruction from a server. The server performs comparison processing of hardware configuration information, and performs storage and management processing. Further, the management program in accordance with this embodiment of the present invention is classified into the following; a management program executed in the client at the time of executing the BIOS, a management program executed under the direction of the OS in the client after the OS is activated, and further a management program executed in the server side.

In FIG. 10, first, the management program in the server transmits to the client a start signal of the hardware configuration information acquisition processing (S30). On receipt of the start signal, power of the client computer is switched on (S31), and thereby the BIOS in the client is activated. This automatically activates execution of the management program to be executed at the time of executing the BIOS, and the hardware configuration information acquisition processing at the time of executing the BIOS is performed (S32). This hardware configuration information acquisition processing is similar to the aforementioned processing shown in FIG. 3.

The management program in the client transmits the hardware configuration information acquired in step S32 to the server (S33). When the management program receives the hardware configuration information (S34), the process moves to FIG. 11, and the management program in the server transmits an OS activation instruction signal to the client (S35). The client activates the OS according to the OS activation instruction signal (S36). In addition, the management program in the client to be executed after activation of the OS is set so that the management program is activated automatically by the OS activation.

When the OS is activated, the management program to be executed after activation of the OS successively performs hardware configuration information acquisition processing (S37). This hardware configuration information acquisition processing is similar to the processing shown in FIG. 5.

The management program in the client transmits the hardware configuration information acquired in step S37 to the server (S38). When the management program in the server receives the hardware configuration information (S39), the management program reads out the hardware configuration information to be compared, which was acquired in the past (S40), and performs comparison processing of hardware configuration information which is substantially identical to the above-mentioned processing.

More specifically, the management program in the server compares the readout hardware configuration information, in which a comparison object flag is set, with the hardware configuration information which is acquired this time (S41).

In the comparison performed in step S41, when the entire items of the two hardware configuration information sets completely coincide, the management program in the server displays a consistency message, which is similar to FIG. 7 (a), onto a display screen of the server (S42). When the user operating the server operates to instruct replacement according to the selection message displayed on the display screen shown in FIG. 7 (a) (S45), the management program in the server changes the setting of the comparison object flag (S46).

Meanwhile, in the comparison performed in step S41, when there is any inconsistent item between the two hardware configuration information sets, the management program extracts the inconsistent item(s) of hardware configuration information (S43), and displays onto the server display screen as an inconsistency message similar to FIG. 7 (b) (S44). Moreover, in the inconsistency message screen, the aforementioned selection message is displayed on the display screen, similar to the case of the consistency message. When the hardware configuration information to be compared is to change, the management program in the server changes the setting of comparison object flag (S46).

Further, the server stores in advance the most up-to-date firmware of each device and the version number thereof. After the management program in the server completes the comparison processing of hardware configuration information, the management program compares the most up-to-date version number information with the version number information of each device in the hardware configuration information acquired in the above-mentioned processing (S47). When the inconsistent device is detected and the firmware of the device concerned is to update (S48), the management program in the server transmits the firmware of the device concerned having the most up-to-date version number to the client, and the management program in the client updates the firmware of the device concerned to the received firmware (S49).

In such a way, it becomes possible to manage hardware configuration information of clients under a server in an integrated manner. Further, by making the server acquire in advance the most up-to-date hardware configuration information of the device (for example, device version number information) mounted on each client, it becomes possible to update the hardware configuration information of the device concerned to the most up-to-date contents when the hardware configuration information of a predetermined device in the client is not most up-to-date. This enables to perform easier maintenance of the client. In addition, with respect to device drivers, it is also possible to perform update processing of the version numbers thereof.

### Industrial Applicability

As the present invention has been described, according to the present invention, hardware configuration information, such as version number information of each device in a computer, is obtained in an integrated manner and is stored in a storage medium. Accordingly, it becomes easier to manage hardware configuration information of a computer.

The foregoing description of the embodiments is not intended to limit the invention to the examples illustrated. The scope of the present invention runs to the inventions described in the claims and the equivalents thereof.

What is claimed is:

1. A management method of hardware configuration information by a computer by which hardware configuration information of each device constituting the computer is managed, said management method comprising the steps of:
acquiring hardware configuration information of each device at a plurality of predetermined timing sets; and
recording the acquired hardware configuration information into a predetermined nonvolatile storage medium.

2. The management method of hardware configuration information according to claim 1 further comprising the steps of:
reading out the hardware configuration information acquired in the past and recorded in the nonvolatile storage medium;
comparing the readout hardware configuration information with the acquired hardware configuration information; and
displaying the comparison result onto a predetermined display unit.

3. The management method of hardware configuration information according to claim 1,
wherein the predetermined timing sets are timing at the time of executing BIOS of the computer and/or timing after OS is activated.

4. The management method of hardware configuration information according to claim 1,
wherein the hardware configuration information includes a version number of a program related to each device.

5. The management method of hardware configuration information according to claim 1,
wherein the computer is a client connected to a server through a network,
the server receives client hardware configuration information acquired by the client through the network, and
the server records the received hardware configuration information into the predetermined nonvolatile storage medium.

6. The management method of hardware configuration information according to claim 5,
wherein the hardware configuration information includes a version number of a program related to each device in the client,
the server records the most up-to-date program and a version number thereof with respect to a program related to each device in the client,
the server compares the program version number related to a predetermined device included in the received hardware configuration information with a version number of the most up-to-date program of said predetermined device, and
when the comparison results in inconsistency, the server updates the program related to said predetermined device to the most up-to-date program.

7. A recording medium in which a program managing hardware configuration information of each device constituting a computer is stored, wherein said program comprises:
a process of acquiring hardware configuration information of each device at a plurality of predetermined timing sets; and
a process of recording said acquired hardware configuration information into a predetermined nonvolatile storage medium.

8. The recording medium according to claim 7 in which said program is stored, wherein said program further comprises:
a process of reading out hardware configuration information which was acquired in the past and is stored in the nonvolatile storage medium;
a process of comparing said readout hardware configuration information with the acquired hardware configuration information; and
a process of displaying the comparison result onto a predetermined display unit

9. A computer having a plurality of devices comprising:
an acquisition section by which hardware configuration information of each device is acquired at a plurality of predetermined timing sets; and
a recording section which records said acquired hardware configuration information into a predetermined nonvolatile storage medium.

10. The computer according to claim 9 comprising:
a comparison section which reads out the hardware configuration information acquired in the past and stored in the nonvolatile storage medium, and compares said readout hardware configuration information with the acquired hardware configuration information; and
a display section which displays the comparison result onto a display unit.

11. The computer according to claim 9,
wherein the predetermined timing sets are timing at the time of executing BIOS and/or timing after OS is activated.

12. The computer according to claim 9,
wherein the hardware configuration information includes a version number of a program related to each device.

13. A computer connected through a network to another computer having a plurality of devices comprising:
a reception section which receives hardware configuration information of each device acquired at a plurality of predetermined timing sets from the other computer through the network; and
a recording section which records said received hardware configuration information into a predetermined nonvolatile storage medium.

14. The computer according to claim 13, wherein the hardware configuration information includes a version number of a program related to each device, and said computer comprises:
a comparison section which compares the version number of the program related to each device included in the hardware configuration information received from the other computer with the version number of the most up-to-date program related to said device; and
an update section which updates the program related to the device of the other computer to the most up-to-date program when the comparison results in inconsistency,

15. A recording medium in which a program to be executed by a computer connected through a network to another computer having a plurality of devices is stored, wherein said program comprises:
a process of receiving hardware configuration information of each device acquired at a plurality of predetermined timing sets from the other computer through the network; and
a process of recording said received hardware configuration information into a predetermined nonvolatile storage medium.
